(19) United States
(12) Patent Application Publication
(10) Pub. No.: US 2017/0250993 A1
(43) Pub. Date: Aug. 31, 2017

(54) SYSTEM, APPARATUS AND METHOD FOR ACCESS AND AUTHORIZATION CONTROL

(71) Applicant: GIFTAGRAM, Toronto (CA)

(72) Inventors: Jason REID, Toronto (CA); Richard KAPUSTIN, Toronto (CA)

(21) Appl. No.: 15/510,881

(22) PCT Filed: Sep. 14, 2015
(86) PCT No.: PCT/IB2015/057052

§ 371 Date: Mar. 13, 2017

Related U.S. Application Data
(60) Provisional application No. 62/049,625, filed on Sep. 12, 2014.

(51) Int. Cl. H04L 29/06; H04L 29/08

(52) U.S. Cl. CPC H04L 63/102; H04L 67/146; H04L 63/08; H04L 67/42

(57) ABSTRACT

A control server provides access and authorization control by: receiving an access request (including a resource identifier and a recipient device identifier) from a sender device; obtaining sender authorization data identifying a sender account corresponding to the sender device; retrieving an access server identifier corresponding to the resource identifier, and destination authorization data identifying a destination account corresponding to the access server identifier; sending a first authorization request (including the sender and destination authorization data) to an authorization server; receiving and storing a token from the authorization server; receiving an access confirmation message from the recipient device; responsive to the access confirmation message, transmitting a second authorization request (including the token) to the authorization server; and responsive to an authorization confirmation message from the authorization server, sending an access instruction (including the resource identifier and delivery data for the recipient client device) to the access server, for delivering the resource.

### CROSS-REFERENCE TO RELATED APPLICATIONS

This application claims priority from U.S. provisional patent application No. 62/049625, filed Sep. 12, 2014, the contents of which is incorporated herein by reference.

### FIELD

The specification relates generally to communications systems, and specifically to a system, apparatus and method for access and authorization control in a communications system.

### BACKGROUND

Various resources (e.g. data, physical articles) can be accessed by computing devices or their operators. In some cases, the granting of access to a given device or that device's operator can be initiated by another device. However, conventional processes for implementing such access control make inefficient use of computational resources and network bandwidth.

### SUMMARY

According to an aspect of the specification, a method of access and authorization control is provided, comprising: receiving, at a control server via a network, an access request from a sender client device; the access control request including a resource identifier and an identifier of a recipient client device; obtaining sender authorization data identifying a sender account corresponding to the sender client device; retrieving, from a memory of the control server, (i) an access server identifier corresponding to the resource identifier, and (ii) destination authorization data identifying a destination account corresponding to the access server identifier; sending a first authorization request from the control server to an authorization server, the first authorization request including the sender authorization data and the destination authorization data; receiving, responsive to the first authorization request, a token from the authorization server, and storing the token in the memory; receiving an access confirmation message at the control server from the recipient client device; responsive to receiving the access confirmation message, transmitting a second authorization request from the control server to the authorization server, the second authorization request including the token; and responsive to receiving an authorization confirmation message from the authorization server, sending an access instruction to the access server, the access instruction including the resource identifier and delivery data associated with the recipient client device for delivering the resource.

According to another aspect of the specification, a control server is provided, comprising: a memory; a network interface; and a processor connected to the memory and the network interface, the processor configured to: receive, via the network interface, an access request from a sender client device; the access control request including a resource identifier and an identifier of a recipient client device; obtain sender authorization data identifying a sender account corresponding to the sender client device; retrieve, from the memory, (i) an access server identifier corresponding to the resource identifier, and (ii) destination authorization data identifying a destination account corresponding to the access server identifier; send a first authorization request to an authorization server, the first authorization request including the sender authorization data and the destination authorization data; receive, responsive to the first authorization request, a token from the authorization server, and store the token in the memory; receive an access confirmation message via the network interface from the recipient client device; responsive to receiving the access confirmation message, transmit a second authorization request to the authorization server via the network interface, the second authorization request including the token; and responsive to receiving an authorization confirmation message from the authorization server, send an access instruction to the access server via the network interface, the access instruction including the resource identifier and delivery data associated with the recipient client device for delivering the resource.

### BRIEF DESCRIPTIONS OF THE DRAWINGS

Embodiments are described with reference to the following figures, in which:

FIG. 1 depicts a communications system, according to a non-limiting embodiment;

FIG. 2 depicts certain internal components of the control server and sender client computing device of FIG. 1, according to a non-limiting embodiment;

FIGS. 3A and 3B depict a method of access and authorization control, according to a non-limiting embodiment.

### DETAILED DESCRIPTION OF THE EMBODIMENTS

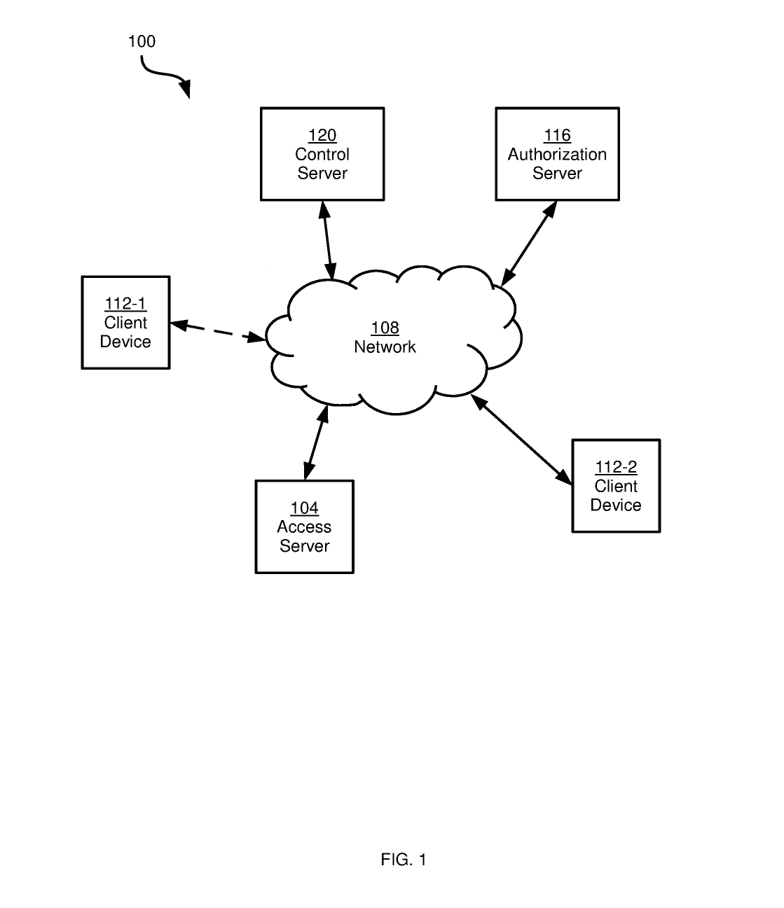

FIG. 1 depicts a communications system 100. System 100 includes at least one access server 104 connected to a network 108. Access server 104 can be implemented as any of a variety of computing devices, and thus generally includes one or more processors (e.g. integrated circuits such as a central processing unit), memory, and network interface components for communicating with other devices via network 108.

Access server 104 is configured to control access to various resources by other computing devices and the operators of such computing devices. In some embodiments, the resources include data, such as electronic publications, media such as music, and the like. Access server 104, in such embodiments, therefore maintains subscription records identifying which computing devices have access to the resources, and can store the resources in memory, or redirect computing devices with access to another server that stores the resources.

In other embodiments, the resources include physical articles, such as clothing, jewelry, and the like. Access server 104, in such embodiments, therefore stores inventory records identifying the articles, and can generate instructions for warehouse or retailer staff to retrieve and ship the articles to a given destination (thus granting access to the articles to a person at the destination).

In other words, access server 104 stores data representative of an inventory of resources, and is configured to cause the resources to be delivered to various destinations either electronically or physically. Various conventional implementations of access server 104 will now be apparent to those skilled in the art. Although only one access server 104 is depicted, it is contemplated that system 100 can include a plurality of access servers 104. For example, each access server 104 can be operated by a different entity (e.g. a retailer) and each access server 104 can therefore be configured to grant access to a different set of resources (i.e. a different inventory).

Network 108 can include a wired network, a wireless network, or any suitable combination of wired and wireless networks, including but not limited to a Wide Area Network (WAN) such as the Internet, a Local Area Network (LAN) such as a corporate data network, cell phone networks, WiFi networks, WiMax networks and the like.

System 100 also includes a plurality of client computing devices (also referred to as client devices), of which two examples 112-1 and 112-2 (collectively referred to as client devices 112) are illustrated. In the discussion below, client device 112-1 will also be referred to as a sender client device, while client device 112-2 will also be referred to as a recipient client device. Client devices 112 can each be implemented as any of a variety of computing devices, including desktop computers, smart phones, tablet computers and the like. Certain internal components of client device 112-1 will be discussed in greater detail below. Client devices 112 are connected to network 108 via wireless (as illustrated in connection with client device 112-1), wired (as illustrated in connection with client device 112-2), or a combination of wireless and wired communication links.

Sender client device 112-1, as will be discussed in greater detail below, is configured to request that access to certain resources be granted to recipient device 112-2 (where the resources include data hosted at access server 104 or an associated server), or the operator of recipient device 112-2 (where the resources include physical articles).

System 100 also includes an authorization server 116 connected to network 108. Authorization server 116 can be implemented as any of a variety of computing devices, and thus generally includes one or more processors (e.g. integrated circuits such as a central processing unit), memory, and network interface components for communicating with other devices via network 108. Authorization server 116 maintains, in the above-mentioned memory, account data corresponding to client device 112-1 (as well as any other sender client device present in system 100) and access server 104. In some embodiments, rather than storing such account data locally, authorization server 116 can communicate with one or more other computing devices (not shown) that store the account data.

Various types of account data are contemplated. For example, in the embodiments discussed herein the account data includes an account balance (e.g. a monetary balance) associated with the device to which the account data corresponds. As will now be apparent to those skilled in the art, authorization server 116 can be implemented as a conventional payment processor server, such as that operating in the Society for Worldwide Interbank Financial Telecommunication (SWIFT) payment network (SwiftNet). In embodiments in which the account data is stored not directly on authorization server 116 but on other computing devices not illustrated in FIG. 1, it will now be apparent that such other computing devices can include servers operated by financial institutions such as banks or credit unions. Although a single authorization server is illustrated in FIG. 1, it is contemplated that system 100 can include a plurality of authorization servers (including, for example, other payment processors).

Access server 104 is configured to grant access to resources only upon receipt of an indication that an account associated with access server 104 maintained at authorization server 116 has been updated (e.g. to reflect an increment to the account balance, indicating payment for the data or articles to which access is to be granted). Authorization server 116, in turn, can make such updates to account data (e.g. decrementing one account balance and incrementing another account balance) in response to an authorization request that identifies a source account identifier and a destination account identifier (e.g. the account associated with access server 104).

System 100 also includes a control server 120. As will be discussed in greater detail below, control server 120 intermediates between client devices 112, access server 104 and authorization server 116 to receive requests from sender client device 112-1, authorize and perform updates to account data at authorization server 104, and grant access to recipient device 112-2 at access server 104.

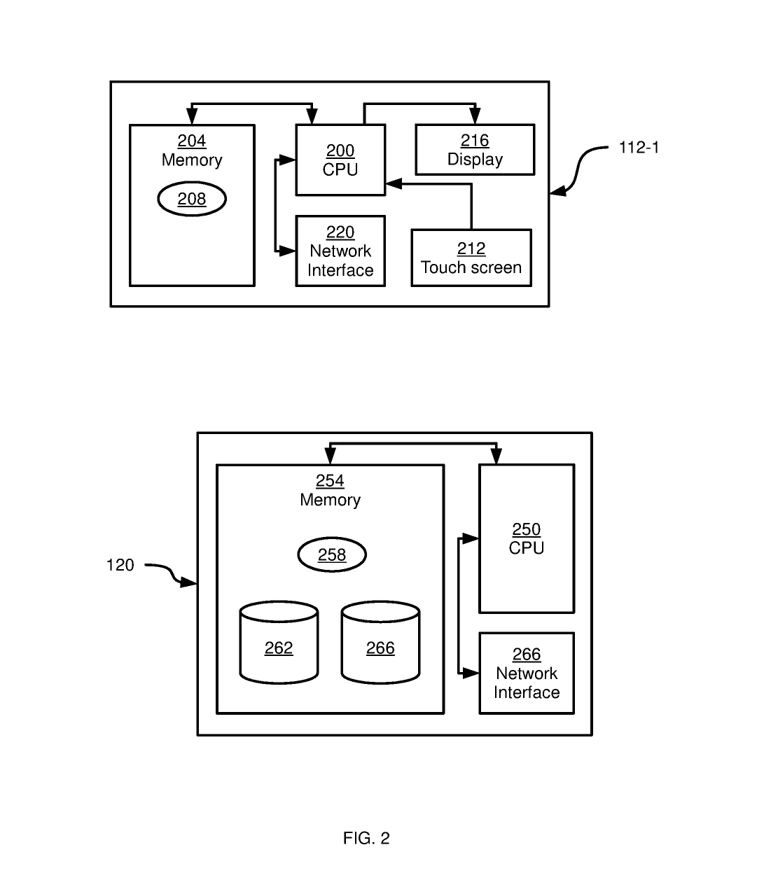

Before a detailed discussion of the operation of system 100 is provided, certain components of client device 112-1 and control server 120 will be described with reference to FIG. 2.

Referring now to FIG. 2, client device 112-1 includes a central processing unit (CPU) 200, also referred to herein as processor 200, interconnected with a memory 204. Memory 204 stores computer readable instructions executable by processor 200, including an application 208. Application 208 can be a purpose-built application for interacting with control server 120, a web-browser application permitting device 112-1 to interact with control server 120 via a web page hosted at control server 120, or a combination thereof. It will now be apparent to those skilled in the art that memory 204 can also store other applications (e.g. an operating system).

Processor 200 and memory 204 are generally comprised of one or more integrated circuits (ICs), and can have a variety of structures, as will now occur to those skilled in the art (for example, more than one CPU can be provided). Processor 200 executes the instructions of application 208 to perform, in conjunction with the other components of client device 112-1, various functions related to granting access to resources to client device 112-2 (via control server 120). Client device 112-1 is therefore said to be configured to perform those functions—it will be understood that client device 112-1 is so configured via the processing of the instructions in application 208 by the hardware components of client device 112-1 (including processor 200 and memory 204).

Client device 112-1 also includes at least one input device interconnected with processor 200. In the present example, an input device in the form of a touch screen 212 is shown connected with processor 200. Client device 112-1 can also include other input devices in addition to (or instead of) touch screen 212, such as any suitable combination of a camera, a microphone, a keyboard, and the like (not shown).

Client device 112-1 also includes at least one output device interconnected with processor 200, such as a display 216 (in the present example, display 216 is integrated with touch screen 212). Other output devices can also be provided, such as a speaker (not shown). Client device 112-1 also includes a network interface 220 interconnected with processor 200, which allows client device 112-1 to connect to network 108. Network interface 220 thus includes the necessary hardware, such as radio transmitter/receiver units, network interface controllers and the like, to communicate with network 108.

Still referring to FIG. 2, control server 120 includes a central processing unit (CPU) 250, also referred to herein as processor 250, interconnected with a memory 254. Memory 254 stores computer readable instructions executable by processor 250, including an access and authorization application 258 (also referred to as application 258). Processor 250 and memory 254 are generally comprised of one or more integrated circuits (ICs), and can have a variety of structures, as will now occur to those skilled in the art (for example, more than one CPU can be provided). Processor 250 executes the instructions of application 258 to perform, in conjunction with the other components of control server 120, various actions related to processing requests from client device 112-1 to grant access to resources to client device 112-2. In the discussion below of those functions, control server 120 is said to be configured to perform those functions, or to be operating to perform those functions—it will be understood that control server 120 is so configured via the processing of the instructions in application 258 by the hardware components of control server 120 (including processor 250 and memory 254).

Control server 120 also includes a network interface 266 interconnected with processor 250, which allows control server 120 to connect to network 108. Network interface 266 thus includes the necessary hardware, such as network interface controllers and the like, to communicate over network 108. Control server 120 can also include input and output devices interconnected with processor 250, such as a keyboard, a mouse and a display (not shown). In some embodiments, such input and output devices can be connected to processor 250 via network 108 and another computing device. In other words, the input and output devices of control server 120 can be local to control server 120 or remote.

In addition to application 258, memory 254 stores a sender client device database 262 and an inventory database 266. In general, database 262 contains a record for each sender client device (e.g. device 112-1). An example database 262 is shown in Table 1, below.

TABLE 1
Example Sender Client Device Database 262

| Device Identifier | Authorization Data |
|---|---|
| 112-1 | card no.: 1234 567 890 |
| | expiry: May 2016 |
| . . . | . . . |

As seen above, database 262 includes a record for each sender client device that is configured to interact with control server 120. Each record includes at least an identifier of device 112-1. The identifier can take a variety of forms, including any one of, or any combination of, an email address, a telephone number, a user name, a name of an operator of device 112-1, and so on. In some embodiments, database 262 can also include authentication data, such as a password, that device 112-2 must provide in order to interact with control server 120.

In addition, each record of database 262 can contain authorization data corresponding to the relevant sender client device. In some embodiments, as will be discussed below, the authorization data can be omitted. As seen in Table 1, the authorization data identifies an account at authorization server 116 (or a financial server connected to authorization server 116), in the form of a credit card number. Additional data, such as an expiry date for the credit card number, can also be included. A variety of other types of authorization data (e.g. deposit account information instead of or in addition to credit card information) can also be stored in database 262. Further, in some embodiments the authorization data can include additional parameters, such as a username and password if required by authorization server 116 to update an account.

Database 266, meanwhile, contains a record for each resource that is accessible via access server 104 (and any other access servers included in system 100). An example of database 266 is shown below in Table 2.

TABLE 2
Example Inventory Database 266

| Item ID | Price | Access Server | Authorization data | Item Type |
|---|---|---|---|---|
| Item-1 | $15.00 | 104 | 12345 | physical |
| Item-2 | $21.00 | 104 | 12345 | digital |
| . . . | . . . | . . . | . . . | . . . |

As seen above, inventory database 266 includes a record for each resource (also referred to as item) to which access can be granted by access server 104 and any other access servers in system 100. Each item record includes an identifier of the item, a price of the item, and an identifier of the access server responsible for granting access to the item. Each item record also includes authorization data identifying an account at authorization server 116 associated with the access server identified in the record. Further, each record can include an indication of item type—that is, an indication of whether the item is physical or digital.

A wide variety of other data can also be included in each record of inventory database 266. For example, item descriptions, images of items and the like can also be stored in database 266. As a further example of data that can be stored in database 266, an item may have selectable attributes, such as size and colour (e.g. for an item of clothing) or a length of time (for a subscription granting access to data at access server 104). In some embodiments, database 266 can also include an indication of a geographic area within which access may be granted to the item. That is, the geographic area specifies a set of locations in which recipient devices 112 (or operators of recipient devices 112) can be granted access to the item. The geographic area can be specified by postal codes (e.g. zip codes), latitudes and longitudes, or any other suitable location indicators. In further embodiments, database 266 can also include indications of a courier service to be used for item delivery (in the case of physical items). In still further embodiments, database 266 can also include an identifier of an authorization server to which authorization requests are to be directed (e.g. when system 100 includes a plurality of authorization servers).

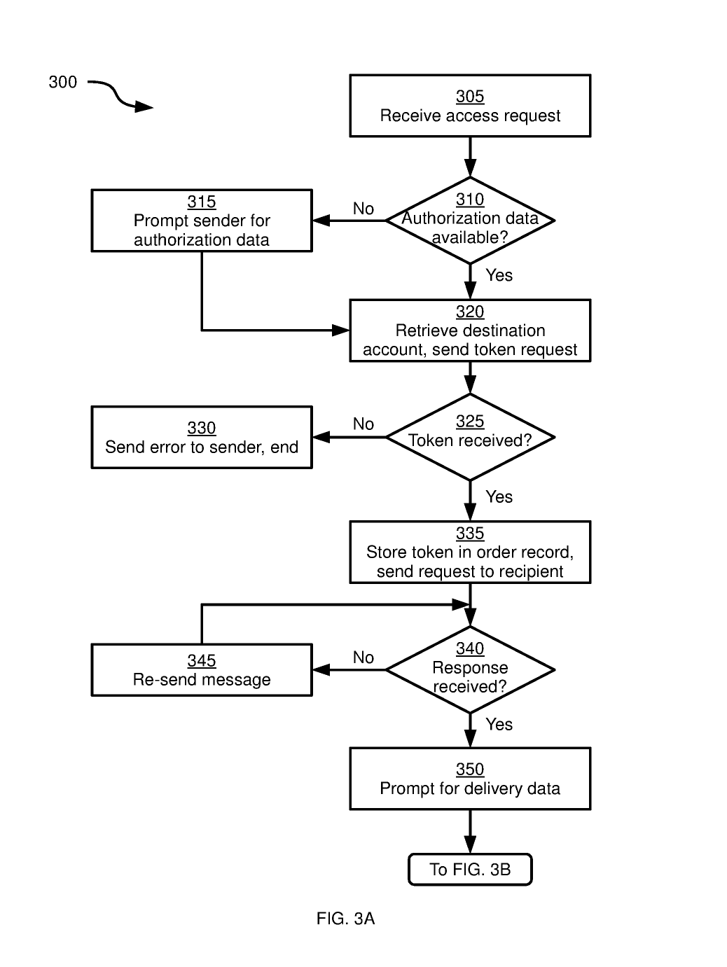

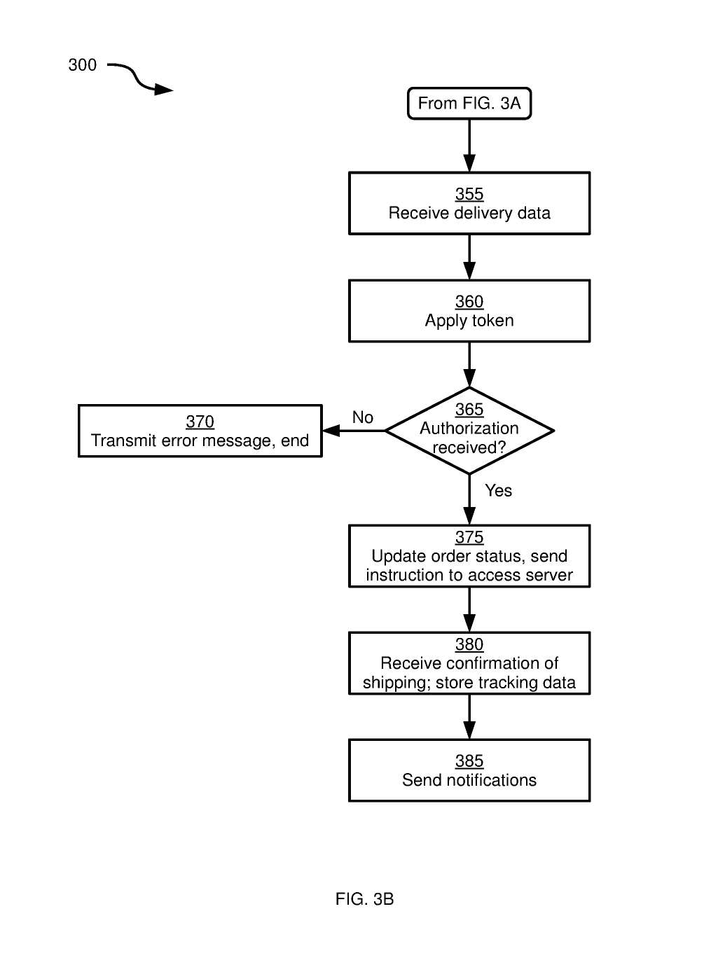

Turning now to FIG. 3A, a method 300 of access and authorization control is illustrated. Method 300 will be described in conjunction with its performance in system 100, and more specifically by control server 120. That is, the blocks of method 300 are performed by processor 250, via the execution of application 258 and in conjunction with the other components of control server 120 discussed above.

Prior to the performance of method 300, control server 120 can provide to client device 112-1 data representing one or more items. For example, control server 120 can serve a web page to client device 112-1 (e.g. following receipt of authentication information matching a record in database 262, as shown above) that includes the item descriptions, images and prices of at least a subset of the items represented in database 266. Sender client device 112-1 is configured to receive the item data and present the item data, for example on display 216.

At block 305, control server 120 is configured to receive an access request from sender client device 112-1, via network 108. In general, the access request includes an item identifier (selected from the items displayed at client device 112-1, for example via touch screen 212), a sender identifier—that is, an identifier of sender client device 112-1—and a recipient identifier identifying a client device 112 to be granted access to the item identified in the request (or associated with an operator to be granted access to the item, in the case of physical items). A variety of recipient identifiers are contemplated, including telephone numbers, email addresses, instant messaging account identifiers, and the like. In some embodiments, application 208 at sender client device 112-1 is configured, in response to the selection of an item, to retrieve contact records (not shown in FIG. 2) stored in memory 204 and present the contact records on display 216 for selection. Upon selection of a contact record, an identifier can be retrieved from the selected contact record and included in the access request. It is also contemplated that in some performances of method 300, the recipient identifier can be the same as the sender identifier (that is, device 112-1 can request access to a resource for itself).

Responsive to receiving the access request at block 305, control server 120 is configured to determine, at block 310, whether authorization data exists in the record of database 262 corresponding to the sender identifier. When authorization data is not available, control server 120 transmits a prompt (e.g. a web page including input fields) to sender client device 112-1 at block 315, for entry of authorization data. In the present example, however, as shown in Table 1, authorization data corresponding to sender client device 112-1 is already stored in database 262. Therefore, the determination at block 310 is affirmative, and the performance of method 300 proceeds to block 320.

At block 320, control server 120 is configured to either receive authorization data from sender client device 112-1 (via the prompt sent at block 315) or retrieve the authorization data from database 262 (when the authorization data is already stored in database 262, as determined at block 310). Control server 120 is also configured to retrieve authorization data associated with the item identified in the request from block 305. For example, as shown in Table 2, the authorization data identifies an account associated with access server 104. In other words, control server is configured to obtain both source authorization data corresponding to sender client device 112-1, and destination authorization data corresponding to access server 104.

Having retrieved authorization data for sender client device 112-1 and access server 104, control server 120 is configured to initiate a first stage of authorization for updating the accounts mentioned above (in other words, the sender account associated with client device 112-1 and the destination account associated with access server 104). Control server 120 is configured to initiate the first stage of authorization by sending a first authorization request, also referred to herein as a token request, to authorization server 116 via network 108. The token request includes identifiers of the source and destination accounts, as well as an amount (e.g. the price of the item from the request at block 305, retrieved from database 266). As will now be apparent to those skilled in the art, the token request causes authorization server 116 to determine whether the account information in the request is valid, and in some cases whether the origin account balance is sufficient to accommodate the price in the request. Token requests, the activities performed by authorization server 116 in processing and responding to the token requests, and the tokens themselves, are implemented conventionally. For example, authorization server 116 can inspect local account records, or send further inquiries to financial servers to determine the validity of the information in the token request.

At block 325, control server 120 is configured to determine whether the response from authorization server 116 includes a token. If the response does not include a token (e.g. because authorization server 116 has determined that the origin account is not valid or contains an insufficient balance), control server 120 performs block 330. At block 330, an error message (e.g. “there was a problem validating your credit card”) can be transmitted to sender client device 112-1 for presentation on display 216, and the performance of method 300 ends.

When the determination at block 325 is affirmative, however (that is, when a token is received from authorization server 116 in response to the request sent at block 320), the performance of method 300 proceeds to block 335. At block 335, control server 120 is configured to store the token (e.g. an alphanumeric string unique to the first authorization request sent at block 320) in memory 254. More specifically, control server 120 is configured to create an order record in memory 254 in response to an affirmative determination at block 325, and store the token in the order record. Tokens, as received from authorization server 116, can include expiry dates in some embodiments (e.g. 30 days from issuance of the token). Control server 120 can be configured to store the expiry date in the order record, although this can be omitted.

The order record also includes the item identifier, the sender identifier, and the recipient identifier. As will now be apparent to those skilled in the art, the order record can include additional information, such as the price of the item. In some embodiments, the request at block 305 can include a message (e.g. a string of text) provided by sender client device 112-1 and intended for delivery to recipient client device 112-2. In such embodiments, the order record can also contain the message.

The order record created at block 335 also includes an order status indicator, indicating whether the requested access has been granted. Currently (that is, at block 335) the status indicates that the access request received at block 305 is pending. In addition to the above, the order record can include a network identifier that is unique to the order record (that is, to the access request received at block 305), generated by control server 120 and to be employed (as will be seen below) by recipient client device 112-2 for interacting with control server 120. The network identifier can be, for example, a uniform resource locator (URL) for an order-specific web page, a telephone number for an interactive voice response (IVR) system, or the like. In other embodiments, the network identifier may be omitted.

Having created the order record and stored the token therein at block 335, control server 120 is configured to send an access confirmation request to the recipient client device (e.g. device 112-2) identified in the request from block 305. The access confirmation request includes an indication that the access grant request from block 305 was received, and can also (but need not necessarily) include one or more of the identifier of sender client device 112-1, the above-mentioned message included in the request of block 305, and the item identifier from the request at block 305. In some embodiments, the access confirmation request can also include additional item information, such as an item description, image, price or the like, retrieved from database 266. Further, when the order record mentioned above includes a network identifier, the access confirmation request includes the network identifier.

The access confirmation request can be transmitted to recipient client device 112-2 in a variety of ways. For example, the transmission mechanism can be selected by control server 120 based on the nature of the recipient identifier received at block 305. That is, if the recipient identifier included a telephone number, the access confirmation request can be transmitted as a short messaging service (SMS) message. Other transmission mechanisms at block 335 include email, instant messaging, and the like.

At block 340, control server 120 is configured to determine whether a response to the access confirmation request has been received from recipient client device 112-2. The nature of the response detected at block 340 can vary based on the nature of the access confirmation request transmitted at block 335. For example, when the access confirmation request includes a URL or IVR telephone number unique to the access request from block 305, the determination at block 340 is affirmative when control server 120 receives a selection of the URL or a call to the IVR number. The determination at block 340 can be based on a time period. For example, if no response has been received at the end of a preconfigured time period (e.g. one day), the determination at block 340 can be negative.

When the determination at block 340 is negative, control server 120 is configured to re-send the access confirmation request at block 345, and return to block 340. In some embodiments, control server 120 can be configured to repeat blocks 340 and 345 only a predetermined number of times (rather than indefinitely) when no response is received. After the predetermined number of attempts is reached, the performance of method 300 can cease, and control server 120 can update the status of the above-mentioned order record to indicate that the access request has failed. In other embodiments, after the predetermined number of repeated access confirmation requests has been sent, control server 120 simply continues to wait for a response, without sending further confirmation requests. That is, the status of the order record is not updated to indicate a failed access request.

Responsive to an affirmative determination at block 340—for example, when the a request for the URL in the access confirmation request is received at control server from recipient client device 112-2—control server 120 performs block 350. At block 350, control server 120 is configured to prompt recipient client device 112-2 for access delivery data. The access delivery data can be, for example, a physical address to which physical articles identified in the access request can be delivered. When the articles identified in the access request (received at block 305) are digital, the access delivery data can instead be an email address or other identifier of client device 112-2. Digital access delivery data can also include authentication data, such as a username and password. The type of delivery data to prompt recipient device 112-2 for at block 350 can be determined by control server 120 based on the “item type” field of database 266, shown in Table 2. In other embodiments, database 262 can explicitly identify the required delivery data for each item.

In some embodiments, the performance of block 350 can be preceded by additional prompts for data from recipient client device 112-2. More specifically, in the above description a response from recipient client device 112-2 is assumed to be an acceptance of the access request. That is, client device 112-2 is assumed, by responding to the access confirmation request, to accept the grant of access initially requested by sender client device 112-1. For example, the access request can identify an article to be sent to the operator of recipient client device 112-2 as a gift, and the receipt of a response from recipient client device 112-2 indicates acceptance of the gift. However, in some embodiments control server 120 can be configured, upon receipt of a response (e.g. the selection of the above-mentioned URL) at block 340, to prompt recipient client device 112-2 for an explicit acceptance or denial of access. Thus, prior to performing block 350, control server 120 can be configured to determine whether recipient client device 112-2 has indicated acceptance or denial of the access confirmation request. When recipient client device 112-2 indicates denial, the performance of method 300 ceases.

It is also contemplated that, when the resource to which access was requested for client device 112-2 at block 305 has selectable attributes (as defined in database 262), at block 350 control server 120 can also prompt recipient client device 112-2 to select such attributes (e.g. a size and colour for an item of clothing).

The illustration of method 300 continues on FIG. 3B, at block 355. At block 355, control server 120 is configured to receive delivery data from recipient client device 112-2 in response to the prompt provided to recipient client device 112-2 at block 350. In some embodiments, control server 120 is configured to verify the validity of the delivery data. For example, control server 120 can be configured to validate a physical address by sending a request to a mapping server (not shown) to ascertain whether the physical address exists. Additionally, when the record of database 262 corresponding to the resource identified in the access request at block 305 includes a geographic area, control server 120 can be configured to determine whether the delivery data falls within the geographic area. When the determination is negative, control server 120 can prompt recipient client device 112-2 for revised delivery data, or can simply terminate the performance of method 300 and transmit an error message to one or both of recipient client device 112-2 and sender client device 112-2. In other embodiments, when the determination is negative, control server 120 can prompt sender client device 112-1 to select a different item to replace the originally selected item. Control server 120 can, for example, provide a set of items for selection to client device 112-1 that have prices matching the originally selected price (so that the token obtained at block 325 remains valid) and that have geographic areas encompassing the delivery data.

Responsive to receiving delivery data (and successfully validating the delivery data if necessary), control server 120 is configured to initiate a second authorization stage at block 360. Control server 120 initiates the second authorization stage by transmitting a second authorization request to authorization server 116. The second authorization request includes the token, which control server 120 is configured to retrieve from the order record in memory 254. The second authorization request also includes an instruction to authorization server 116 to process the token and update the source and destination accounts identified in the token request from block 320. As will be apparent to those skilled in the art, the second authorization request need not include account identifiers, as authorization server 116 is configured to store the account identifiers in memory in association with the token.

At block 365, control server 120 is configured to determine whether a confirmation of authorization has been received from authorization server 116. As will now be apparent to those skilled in the art, following the receipt of the second authorization request containing the token, authorization server 116 is configured to retrieve the source and account identifiers corresponding to the token (which were previously received and stored in memory at authorization server 116), as well as the amount (e.g. the price) previously received from control server 120. Authorization server 116 is then configured to determine whether to authorize the requested update to the source and destination accounts (e.g. decrementing the source account balance by the price, and incrementing the destination account balance by the price). The determination can include interactions with other servers (not shown), and can include, for example, a determination of whether the account balance of the source account is greater than the price.

Following the above-mentioned processes, authorization server 116 is configured to return a message to control server 120. If the requested update was authorized, the message includes transaction details confirming the adjustment made to the account balances of the source and destination accounts. If the requested update was not authorized, the message indicates the authorization failure, and can also indicate a reason for the failure (such as an insufficient account balance in the source account). It will be appreciated by those skilled in the art that although the first authorization stage mentioned above may have confirmed that the source account balance was sufficient to complete the requested account updates, during the time between the token generation and the performance of block 360, other, unrelated changes to the account balance may have resulted in the balance being decreased to the point where it is no longer sufficient.

When the determination at block 365 is negative, at block 370 control server 120 is configured to transmit an error message to one or both of recipient client device 112-2 and sender client device 112-1. Control server 120 is also configured to update the status indicator contained in the above-mentioned order record to indicate that the access request failed. The performance of method 300 can then be terminated. In other embodiments, control server 120 can be configured to repeat the performance of blocks 360 and 365 (which may also include a request for a new token; that is, a repeated performance of blocks 320 and 360 substantially simultaneously) for any failed order records if control server 120 detects an update to the authorization data stored in connection with sender client device 112-1.

When the determination at block 365 is affirmative, at block 375 control server 120 is configured to update the status indicator in the order record to indicate that the access request is confirmed (that is, has succeeded). Control server 120 is also configured to send an instruction to access server 104 to grant access to the requested item to recipient client device 112-2. The instruction to access server 104 includes the item identifier from the request of block 305, as well as the delivery data received at block 355. Where selectable attributes for the item were received with the delivery data, the instruction also includes the selectable attributes.

In some embodiments, particularly when the item to which access has been granted is a physical article, the instruction can also include an identifier of a courier to be employed to physically deliver the item to the operator of recipient client device 112-2. The instruction may also include shipping data generated at control server 120, such as a shipping waybill, label or the like. Various mechanisms for the automated generation of waybills will now occur to those skilled in the art.

The transmission of the above-mentioned instruction to grant access from control server 120 to access server 104 can be implemented in various ways. For example, in the present embodiment control server 120 hosts a web page that access server 104 can retrieve. The web page includes a list of any order records in memory 254 that are associated with access server 104, and thus the request for the web page by access server 104 results in the transmission of the access instruction to access server 104.

In other embodiments, control server 120 can store, in memory 254, a network address for access server 104 (e.g. an IP address, an email address, or the like) and transmit the access instruction to access server 104 without the need for access server 104 to request any information from control server 120. In still other embodiments, the above processes can be implemented via any suitable application programming interface (API) implemented by control server 120 or access server 104.

Following transmission of the access instruction, control server 120 is configured to receive a confirmation of delivery at block 380. The confirmation can be received from access server 104 via the above-mentioned web page. Specifically, access server 104 can request the web page and select one or more order records displayed thereon to indicate that those items have been delivered. In the case of physical items, the confirmation can be provided by access server 104 upon shipping the item, rather than upon arrival of the item at its final destination. In other embodiments, the delivery confirmation can be provided to control server 120 by access server 104, or requested from access server 104 by control server 120, via the above-mentioned APIs.

Having received the delivery confirmation message, control server 120 is also configured to store delivery tracking data, if such data is contained in the confirmation message. The delivery tracking data (such as a tracking number provided by the above-mentioned courier) is stored in the order record.

At block 385, control server 120 can be configured to send notifications regarding delivery status to one or both of sender client device 112-1 and recipient client device 112-2. For example, control server 120 can be configured to send a request to a courier server (not shown), for example using a known API made available by the courier, to retrieve delivery status information corresponding to the above-mentioned tracking number. Control server 120 can be configured to then send one or more notifications based on the delivery information. For example, upon shipping of a physical item, control server 120 can be configured to notify sender client device 112-1. Further, upon final delivery of the item (to the address received at block 355), control server 120 can be configured to notify recipient client device 112-2. In other embodiments, block 385 can be omitted.

Variations to the above systems and methods are contemplated. For example, in some embodiments, rather than identify an account specific to access server 104, the authorization data for at least some records of database 262 can identify an account corresponding to control server 120 itself. In other words, payment for the item to which access is granted is deposited in the account corresponding to control server 120. Control server 120 can then, following the delivery of the item, transmit instructions to authorization server 116 or other financial servers to conduct a further account update to transfer the payment to an account corresponding to access server 104.

In other embodiments, control server 120 can be configured to store any delivery data received at block 355, described above. In such embodiments, any subsequent access requests relating to the device (e.g. recipient client device 112-2) that provided the delivery data can either omit blocks 350 and 355 entirely, or can modify blocks 350 and 355 to prompt device 112-2 to confirm that the previously stored delivery data is correct. When device 112-2 indicates to control server 120 that the previously stored delivery data is not correct, new delivery data can be obtained by performing blocks 350 and 355 as described earlier.

Certain advantages to the above systems and methods will now occur to those skilled in the art. For example, the separation of the first and second authorization stages in method 300 can, under certain conditions, reduce the computational burden on control server 120, authorization server 116 and network 108 in the event of a failed or denied access request, as no updates are made to any accounts at authorization server 116 until access confirmation is received from recipient client device 112-2.

The scope of the claims should not be limited by the embodiments set forth in the above examples, but should be given the broadest interpretation consistent with the description as a whole.

We claim:

1. A method of access and authorization control, comprising:
receiving, at a control server via a network, an access request from a sender client device; the access control request including a resource identifier and an identifier of a recipient client device;
obtaining sender authorization data identifying a sender account corresponding to the sender client device;
retrieving, from a memory of the control server, (i) an access server identifier corresponding to the resource identifier, and (ii) destination authorization data identifying a destination account corresponding to the access server identifier;
sending a first authorization request from the control server to an authorization server, the first authorization request including the sender authorization data and the destination authorization data;
receiving, responsive to the first authorization request, a token from the authorization server, and storing the token in the memory;
receiving an access confirmation message at the control server from the recipient client device;
responsive to receiving the access confirmation message, transmitting a second authorization request from the control server to the authorization server, the second authorization request including the token; and
responsive to receiving an authorization confirmation message from the authorization server, sending an access instruction to the access server, the access instruction including the resource identifier and delivery data associated with the recipient client device for delivering the resource.

2. The method of claim 1, wherein obtaining sender authorization data comprises:
determining whether the sender authorization data is stored in the memory;
when the determination is affirmative, retrieving the sender authorization data from the memory; and
when the determination is negative, prompting the sender client device for the sender authorization data.

3. The method of claim 2, further comprising:
responsive to prompting the sender client device, receiving and storing the sender authorization data from the sender client device.

4. The method of claim 1, further comprising:
responsive to receiving the access request, retrieving an amount corresponding to the item identifier from the memory; wherein the first authorization request includes the amount.

5. The method of claim 1, further comprising:
prior to receiving the access confirmation message and responsive to receiving the token, sending an access confirmation request from the control server to the recipient client device.

6. The method of claim 5, further comprising:
determining whether the access confirmation message has been received in response to the access confirmation request; and
when the determination is negative, repeating the sending of the access confirmation request.

7. The method of claim 1, further comprising:
responsive to receiving the access confirmation message, prompting the recipient client device for the delivery data.

8. The method of claim 7, further comprising:
receiving the delivery data at the control server from the recipient client device;
determining whether the delivery data is valid; and
when the delivery data is not valid, prompting the recipient client device for further delivery data.

9. The method of claim 1, wherein the authorization confirmation message includes an indication that the sender account and the destination account have been updated.

10. The method of claim 5, further comprising:
receiving, responsive to the access confirmation request, a denial message from the recipient client device; and
transmitting an error message to the sender client device.

11. A control server, comprising:
a memory;
a network interface; and
a processor connected to the memory and the network interface, the processor configured to:
receive, via the network interface, an access request from a sender client device; the access control request including a resource identifier and an identifier of a recipient client device;
obtain sender authorization data identifying a sender account corresponding to the sender client device;
retrieve, from the memory, (i) an access server identifier corresponding to the resource identifier, and (ii) destination authorization data identifying a destination account corresponding to the access server identifier;
send a first authorization request to an authorization server, the first authorization request including the sender authorization data and the destination authorization data;
receive, responsive to the first authorization request, a token from the authorization server, and store the token in the memory;
receive an access confirmation message via the network interface from the recipient client device;
responsive to receiving the access confirmation message, transmit a second authorization request to the authorization server via the network interface, the second authorization request including the token; and
responsive to receiving an authorization confirmation message from the authorization server, send an access instruction to the access server via the network interface, the access instruction including the resource identifier and delivery data associated with the recipient client device for delivering the resource.

12. The control server of claim 11, the processor further configured to obtain sender authorization data by:
determining whether the sender authorization data is stored in the memory;
when the determination is affirmative, retrieving the sender authorization data from the memory; and
when the determination is negative, prompting the sender client device for the sender authorization data.

13. The control server of claim 12, the processor further configured to:
responsive to prompting the sender client device, receive and store the sender authorization data from the sender client device.

14. The control server of claim 11, the processor further configured to:
responsive to receiving the access request, retrieve an amount corresponding to the item identifier from the memory; wherein the first authorization request includes the amount.

15. The control server of claim 11, the processor further configured to:
prior to receiving the access confirmation message and responsive to receiving the token, send an access confirmation request to the recipient client device via the network interface.

16. The control server of claim 15, the processor further configured to:
determine whether the access confirmation message has been received in response to the access confirmation request; and
when the determination is negative, repeat the sending of the access confirmation request.

17. The control server of claim 11, the processor further configured to:
responsive to receiving the access confirmation message, prompt the recipient client device for the delivery data.

18. The control server of claim 17, the processor further configured to:
receive the delivery data from the recipient client device;
determine whether the delivery data is valid; and
when the delivery data is not valid, prompt the recipient client device for further delivery data.

19. The control server of claim 11, wherein the authorization confirmation message includes an indication that the sender account and the destination account have been updated.

20. The control server of claim 15, the processor further configured to:
receive, responsive to the access confirmation request, a denial message from the recipient client device; and
transmit an error message to the sender client device.
